(19) United States
(12) Patent Application Publication
(10) Pub. No.: US 2011/0014450 A1
(43) Pub. Date: Jan. 20, 2011

(54) POLYOLEFIN FILM AND USE THEREOF

(75) Inventors: Uwe Michel, Berlin (DE); Bernhard Mü, Seevetal (DE)

Correspondence Address: Briscoe, Kurt G.;Norris McLaughlin & Marcus, PA, 875 Third Avenue, 8th Floor, New York, NY, 10022, US

(73) Assignee: TESA SE, Hamburg (DE)

(21) Appl. No.: 12/863,946

(22) PCT Filed: Jan. 12, 2009
(86) PCT No.: PCT/EP09/50269

§ 371 Date: Oct. 4, 2010

(30) Foreign Application Priority Data
Jan. 22, 2008 (DE) 102008005561.1

(51) Int. Cl. C09J 7/00; B32B 27/00

(52) U.S. Cl. 428/220; 428/343; 428/297.4; 428/515; 525/185; 525/70

(57) ABSTRACT

The invention relates to a polyolefin film, in particular for an adhesive tape, which is monoaxially stretched in the longitudinal direction, characterized in that the film contains a mixture of an olefinic polymer and a polar non-olefinic polymer.

The invention relates to a polyolefin film which is oriented monoaxially in longitudinal direction and to the use thereof.

Films with a high longitudinal strength are typically obtained by orienting extruded film webs comprising partially crystalline thermoplastics. The orientation in question is predominantly biaxial. Exceptionally, the films are oriented only in the longitudinal direction, to achieve a further increase in the longitudinal tensile strength. Not only commercially customary biaxially oriented films but also monoaxially oriented films based on polypropylene, however, have low tear propagation resistances in transverse direction in contrast to unoriented films from the blown film or cast film process.

In practical operation this leads readily, in the case of damaged edges (owing to blunt blades during slitting or subsequent unintended damage to the slit edge), to the film, or the adhesive tape produced therefrom, being torn off under tensile load.

Where the requirements concerning the stiffness (high tensile stress at very low elongation) and concerning the tear propagation resistance in transverse direction are stringent, films and adhesive tapes are reinforced with filaments or with meshes of filaments made from glass or plastic. Producing filament adhesive tapes of this kind is very involved from the equipment standpoint, and is therefore expensive and susceptible to faults. As well as the base film, there is a need additionally for the filaments and laminating adhesive (or an additional coating of pressure-sensitive adhesive), and this makes the products even more expensive. Further disadvantages of filament adhesive tapes of this kind are low crease fracture resistance, high thickness, untidy slit edges, and lack of weldability and recyclability. The production of an adhesive tape of this kind is described in U.S. Pat. No. 4,454,192 A1, for example.

EP 0 255 866 A1 provides a polypropylene film which is oriented biaxially or in longitudinal direction. The described addition of polyethylene to increase the tensile impact toughness in transverse direction, however, results in a reduction in the stiffness in longitudinal direction and in the tear propagation resistance in transverse direction. The draw ratio in longitudinal direction is 1:5.5 to 1:7. Tensile strengths of 12 to 355 N/mm² are attained. No details are provided of the tensions at 10% elongation or of the tear propagation resistance in transverse direction.

At the end of the 1980s, the company Beiersdorf (Hamburg, Germany) marketed a tear-open strip exhibiting reduced tendency to become torn off. It contained a longitudinally oriented carrier film from the company NOPI (Harrislee, Germany) which was produced by coextrusion of raw materials with different toughnesses, and had a draw ratio of 1:7.5. Operating on the principle of impact modifiers, the tough outer coextrusion layer reduces the formation of microtears when the product is slit with sharp blades. It does not, however, prevent tears caused by subsequently damaged edges (for example, when the roll is transported or is applied to the carton), which requires a much higher tear propagation resistance. The outer layer contains 60% by weight of polypropylene copolymer with about 5% by weight of ethylene, and 40% by weight of SBS rubber for increasing the toughness, which impairs the light stability and leads in particular to reduced tensile strength (160 N/mm²) and reduced stress at 10% elongation (70 N/mm²) of the film in longitudinal direction. The less tough main layer contains 92% by weight of the polypropylene copolymer and 8% by weight of the SBS rubber. The SBS rubber lowers the tear propagation resistance of a single-layer film made from pure polypropylene copolymer, with the same draw ratio, from around 240 N/mm to 70 N/mm.

DE 44 02 444 A1 relates to an adhesive tape which possesses tensile strength and is based on monoaxially oriented polyolefin. It is possible to achieve mechanical properties which in certain respects are similar to those of corresponding polypropylene products. Polyethylene, however, has a significantly lower heat resistance than polypropylene, a fact which is manifested disadvantageously not only during the preparation of the adhesive tape (drying of layers of adhesive or other layers in the oven) but also in the context of the subsequent packaging applications, as a grip tape, adhesive carbon sealing tape, tear-open strip or carton reinforcement strip. The adhesive tapes on the cartons often become hot, as for example on passage through printing machines or after filling with hot products (foodstuffs, for example). A further disadvantage of polyolefin films (including oriented PE films) in comparison to polypropylene films is the much lower force at 10% elongation. As a result of the greater elongation for a given force, grip tapes or adhesive carton sealing tapes produced from such films tend toward detachment under tensile load, and carton reinforcement strips are unable to prevent the tearing of cartons. The draw ratio in longitudinal direction and attainable stresses at 10% elongation are not disclosed. Tensile strengths of 102 to 377 N/mm² are attained.

The inventions described above have found applications, but have fallen far short of the tensile strengths and tear propagation resistances of filament adhesive tapes. Consequently there have been attempts made to avoid the involved application of numerous filament threads and to give the oriented films filament-like properties by means of longitudinal structures, this being described below.

U.S. Pat. No. 5,145,544 A1 and U.S. Pat. No. 5,173,141 A1 describe an adhesive tape made from monoaxially oriented film that has a rib structure for reinforcement, with some of the ribs projecting from the surface and some being embedded in the surface of the film. Notch-like joints are formed between film and ribs. The invention attains high lateral tear resistance, but the tensile strength and stretchability are still in need of improvement. The essential defect is that a film in accordance with this invention cannot be produced on the production scale. The reason for this is the poor orientability in conventional width, and also an extremely poor flatness, meaning that the coatability with PSA is no longer ensured. At high widths, moreover, there is a deterioration in the flatness even further, as a result of nonuniform and insufficient adhesion (owing to the film not lying flatly) on the drawing rolls in the subsequent orientation procedure. In the case of manufacture in typical production width, the film is held on the drawing rolls in transverse direction in the middle region, as a result of which the rib structure is altered by orientation and the overall product quality becomes inhomogeneous. A further disadvantage is the need for at least 50% embedding of the ribs by a calendar, which is very expensive as a capital investment and which makes the procedure much more involved. The rib structure on the surface also results readily in coating errors during application of release agents or primers in the course of further processing to adhesive tapes, since the application methods for films require a smooth surface. Imprints of reinforcing filaments or rib structures in the surface of films are disadvantageous for printing, which requires smooth surfaces. Particularly when the film of the invention is utilized for an adhesive packaging tape, printability is, for customers, an important criterion. U.S. Pat. No. 5,145,544 A1 reveals a draw ratio of 1:7 and tensile strengths of 157 to 177 N/mm²; stresses at 10% elongation are not ascertained. U.S. Pat. No. 5,173,141 A1 reveals draw ratios of 1:6.1 to 1:7 and tensile strengths of up to 245 N/mm²; stresses at 10% elongation are not ascertained.

EP 1 101 808 A1 attempts to eliminate the stated disadvantages by moving the rib structures into the interior of the film. The film has plane-parallel outer faces and comprises at least two coextruded layers differing in composition, whose interface is not planar but instead in cross section has a nonlinear boundary profile, which continues in a laminar fashion in longitudinal direction. The particular internal structure of the film derives from the fact that the thickness of a layer in transverse direction varies periodically or irregularly, and the second layer compensates the fluctuations in thickness in such a way that the overall thickness is substantially constant. All of the stated embodiments have improved tensile strength and elasticity modulus in longitudinal direction as compared with a standard adhesive tape film. The draw ratios are between 1:6.7 and 1:8.7. Tensile strengths achieved are 202 to 231 N/mm², and stresses at 10% elongation achieved are 103 to 147 N/mm².

None of the versions outlined is implemented industrially, since the production methods are very involved. Furthermore, they fall far short of matching the properties of products with glass filaments or polyester filaments.

It is an object of the invention to provide a film, in particular for an adhesive tape, that does not have the stated disadvantages of the prior-art films.

This object is achieved by means of a film of the kind identified more closely in the main claim. The dependent claims describe advantageous embodiments of the invention. Further encompassed by the concept of the invention is the use of the film of the invention.

The invention accordingly provides a polyolefin film which is oriented monoaxially in longitudinal direction and which comprises a mixture of an olefinic and a polar nonolefinic polymer.

The fraction of polar nonolefinic polymer in the mixture is preferably in the range from 5% to 30% by weight.

In order to obtain high tensile strengths, high tensions at 10% elongation, and high tear propagation resistance, the conditions of the drawing operation ought to be selected such that the draw ratio is the maximum which can be carried out technically for the respective film. In accordance with the invention the draw ratio in longitudinal direction is at least 1:4.5, preferably at least 1:7.

A draw ratio of, for example, 1:6 indicates that a section of the primary film with a length of 1 m produces a section of the drawn film of 6 m in length. The draw ratio is often also denoted as the ratio of the linear speed prior to orientation to the linear speed after orientation. The numerical figures used below relate to the drawing operation.

In one preferred embodiment of the invention the properties of the film are as follows:
a tensile strength in longitudinal direction of at least 200 N/mm², preferably at least 300 N/mm², more preferably at least 400 N/mm²,
a stress at 10% elongation in longitudinal direction of at least 150 N/mm², preferably at least 200 N/mm², more preferably at least 250 N/mm², and/or
a tear propagation resistance in transverse direction of at least 400 N/mm, preferably at least 800 N/mm, more preferably at least 1500 N/mm.

Strength values are calculated by dividing the width-based force values by the thickness. Where the strength values are determined on the adhesive tape, the thickness used as a basis is not the total thickness of the adhesive tape, but only that of the carrier film.

The thickness of the carrier film is preferably between 15 and 200 μm, more preferably between 30 and 140 μm, very preferably between 50 and 90 μm.

The olefinic polymer is a homopolymer or copolymer of olefins such as ethylene, propylene or butylene. The term copolymer should be understood logically here to include terpolymers.

The olefinic polymer comprises preferably at least 50% by weight of propylene, and more preferably is a propylene homopolymer.

Particularly suitable base materials for films are commercially available polypropylene homopolymers or polypropylene copolymers, including block (impact) and random polymers.

The melt indices of the stated polymers must lie within the range suitable for flat film extrusion. This range ought to be between 0.3 and 15 g/10 min, preferably in the region of 0.8 and 5 g/10 min (measured at 230° C./2.16 kg).
The polypropylene is preferably of predominantly isotactic construction. The flexural modulus ought to be at least 1000 MPa, preferably at least 1500 MPa, very preferably at least 2000 MPa.

A polar nonolefinic polymer comprehends all polymers which a) contain no olefin monomer such as ethylene, propylene or butylene, for example, and b) comprise as a polar component heteroatoms such as sulfur, nitrogen, phosphorus, and—preferably—oxygen. The polar nonolefinic polymer is preferably selected from the group of polyesters, polyamides, polyurethanes, polyoxymethylene, polyarylene sulfides, and polyarylene oxides. Partially crystalline polymers are particularly preferred. In one particularly advantageous embodiment of the invention a selection is made, as polar nonolefinic polymer, of polybutylene terephthalate and/or polyoxymethylene.

In the preferred embodiment the matrix is composed of the olefinic polymer with the polar nonolefinic polymer embedded therein in the form of fibers.

The fibers preferably have a diameter of 0.01 to 50 μm, more preferably 0.1 to 20 μm.

The dimensions of the fibers and hence the mechanical properties of the film can be adjusted through the preparation procedure and through the addition of a polar-modified polyolefin as a third component in the mixture.

The polar-modified polyolefin is preferably selected from the group of the copolymers of olefins with vinyl esters, methacrylic acid and acrylic acid, more preferably ethylene-vinyl acetate copolymers and ethylene-(meth)acrylate copolymers, and esters thereof, or from the group of graft polymers with an unsaturated organic acid, more preferably a maleic anhydride-, methacrylic acid- or acrylic acid-grafted polyolefin, and the fraction of polar-modified polyolefin in the mixture is preferably in the range from 0.2% to 10% by weight.

The polymers of the film can be used in pure form or in a blend with additives such as antioxidants, light stabilizers, antiblocking agents, lubricants, and processing assistants, fillers, dyes, pigments, blowing agents or nucleating agents.

The film can be used, for example, as a carrier for an adhesive tape. An adhesive tape of this kind is suitable for reinforcing cardboard packaging, particularly in the area of die cuts, as a tear-open strip for cartons, and for bundling articles. Examples of such articles include pipes, profiles or stacked cartons (strapping application). Since the film of the invention is practically impossible to tear through in transverse direction, even in the case of damaged edges, it is possible to prevent instances of torn removal of tear-open strips, or the continued tearing of reinforced carton die cuts. In such films, a tear tends to run in the longitudinal direction, and this, in the case of edge damage or partial die cutting, prevents torn removal in transverse direction, by diverting the tear into the longitudinal direction.

The preferred procedure for producing the film, or for producing an adhesive tape of this invention that is produced using the film, comprises the following steps:
Polymers and, where used, additives are mixed and supplied in an extruder to a flat film die.
The melt film is then subjected to controlled cooling on a chill roll.
Before the film web is passed to the drawing apparatus, it is heated to a suitable drawing temperature via heated rolls.
The film is then subjected to short-gap orientation in machine direction.
The carrier film is provided with an adhesive by coating or even before by coextrusion.

The film may be single-layer or multilayer; preferably it is multilayer, more preferably of the ABC type, where B comprises the mixture of the invention and A and/or C are composed wholly or predominantly of polyolefinic polymer. In films of this kind without coextrusion layers, fibers may emerge from the surface of the films, and may cause disruption in the course of further processing. This applies particularly to the case of especially high orientation with the aim of achieving high stress values at 1% and 10% elongation. Coextrusion allows fiber deposition during the orientation of the film, and problems during coating with release, primer or adhesive, to be avoided. Preference is therefore given to a three-layer film of construction ABA, where B comprises the mixture of the invention and the outer layers A are composed of at least one polyolefin. The polyolefin of layer A is preferably either the polyolefin of layer B or a polypropylene homopolymer. A further advantage which has become apparent for one or more A layers or for an A layer and a B layer is a relatively high toughness of the film in transverse direction. As a result, the film tends less to tear under transverse load. Furthermore, this also increases the toughness perpendicular to the film surface; in other words, in the case of coating defects (local absence of release coating through electrostatic charging of the film) there is a fall in the risk of shredding (splitting of the film in the third dimension).

The film may be modified by lamination, embossing or radiation treatment.

The film may be provided with surface treatments. These are, for example, for the purpose of promoting adhesion, corona treatment, flame treatment, fluoro treatment or plasma treatment, or coatings of solutions or dispersions, or liquid, radiation-curable materials. Other possible coatings are printed coatings and nonstick coatings, examples being those of crosslinked silicones, acrylates (for example, Primal® 205), polymers with vinylidene chloride or vinyl chloride as monomer, or stearyl compounds such as polyvinyl stearylcarbamate or chromium stearate complexes (for example, Quilon® C) or reaction products of maleic anhydride copolymers and stearylamine.

A preferred adhesive tape in accordance with the invention is a film having a self-adhesive or heat-activatable layer of adhesive. The adhesives in question, however, are preferably not sealable adhesives, but instead are pressure-sensitive adhesives. For the adhesive tape application, the film is coated on one or both sides with pressure-sensitive adhesive in solution or dispersion or 100% form (for example, from the melt) or by coextrusion with the film. The adhesive layer or layers can be crosslinked by heat or high-energy radiation and can if necessary be lined with release film or release paper. Particular suitability is possessed by pressure-sensitive adhesives based on acrylate, natural rubber, thermoplastic styrene block copolymer or silicone.

The general expression “adhesive tape” encompasses, for the purposes of this invention, all sheetlike structures such as two-dimensionally extended films or film sections, tapes with extended length and limited width, tape sections and the like, and also, lastly, die cuts or labels.

For the purpose of optimizing the properties it is possible for the self-adhesive composition employed to be blended with one or more additives such as tackifiers (resins), plasticizers, fillers, pigments, UV absorbers, light stabilizers, ageing inhibitors, crosslinking agents, crosslinking promoters or elastomers.

Suitable elastomers for blending are, for example, EPDM rubber or EPM rubber, polyisobutylene, butyl rubber, ethylene-vinyl acetate, hydrogenated block copolymers of dienes (for example, by hydrogenation of SBR, cSBR, BAN, NBR, SBS, SIS or IR; such polymers are known, for example, in the form of SEPS and SEBS) or acrylate copolymers such as ACM.

Examples of tackifiers are hydrocarbon resins (for example, of unsaturated C₅ or C₇ monomers), terpene-phenolic resins, terpene resins formed from raw materials such as α- or β-pinene, aromatic resins such as coumarone-indene resins or resins of styrene or α-methyl styrene such as rosin and its derivatives, such as disproportionated, dimerized or esterified resins, in which case glycols, glycerol or pentaerythritol may be used. Particularly suitable are aging-stable resins with no olefinic double bond, such as hydrogenated resins, for example.

Examples of suitable fillers and pigments include carbon black, titanium dioxide, calcium carbonate, zinc carbonate, zinc oxide, silicates or silica.

Suitable UV absorbers, light stabilizers, and ageing inhibitors for the adhesives are those as listed in this specification for the stabilization of the film.

Examples of suitable plasticizers include aliphatic, cycloaliphatic, and aromatic mineral oils, diesters or polyesters of phthalic acid, trimellitic acid or adipic acid, liquid rubbers (for example, nitrile rubbers or polyisoprene rubbers), liquid polymers of butene and/or isobutene, acrylic esters, polyvinyl ethers, liquid resins and plasticizer resins based on the raw materials for tackifier resins, wool wax and other waxes, or liquid silicones.

Examples of crosslinking agents include phenolic resins or halogenated phenolic resins, melamine resins, and formaldehyde resins. Suitable crosslinking promoters are, for example, maleimides, allyl esters such as triallyl cyanurate, and polyfunctional esters of acrylic and methacrylic acid.

One preferred embodiment comprises a pressure-sensitive adhesive composed of natural rubber, hydrocarbon resin, and antioxidant.

The coating thickness with adhesive is situated preferably in the range from 18 to 50 g/m², more particularly 22 to 29 g/m². The thickness of the adhesive tape rolls is situated preferably in the range from 2 to 60 mm.

### Test Methods

Thickness: DIN 53370
Tensile strength: DIN 53455-7-5 in longitudinal direction
Tensile stress at 10% elongation: DIN 53455-7-5 in longitudinal direction
Elongation at break: DIN 53455-7-5 in longitudinal direction
Tensile impact toughness in transverse direction: DIN EN ISO 8256
   (clamped length 10 mm, 7.5 J pendulum, 5 plies, 30 g yoke)
Tear propagation resistance in transverse direction:
DIN 53363-2003-10
Melt index for PP: DIN 53735 (230° C., 2.16 kg)
Melt index for PBT: DIN 53735 (250° C., 2.16 kg)
Melt index for POM/EVAL/PE-LLD: DIN 53735 (190° C., 2.16 kg)
Melt index for PS-HI: DIN 53735 (200° C., 5 kg)
Flexural modulus: ASTM D 790 A
Technical adhesive data: AFERA 4001 (corresponding to DIN EN 1939)

The intention of the text below is to illustrate the invention using examples, without restricting it as a result.

### EXAMPLES

### Base Materials

Dow 7C06:

PP block copolymer, MFI 1.5 g/10 min, non-nucleated, flexural modulus 1280 MPa (Dow Chemical)

Bormod HD 905 CF:

PP homopolymer, MFI 6 g/10 min, flexural modulus 2150 MPa, contains an α-nucleating agent (Borealis)

Dowlex 2032:

PE-LLD, MFI 2 g/10 min (Dow Chemical)

Styron 457

PS-HI, MFI 3 g/10 min, flexural modulus 2200 MPa (Dow Chemical)

EVAL G156B:

EVAL, ethylene content 48 mol %, MFI 6.4 g/10 min, flexural modulus 2800 MPa (EVAL Europe)

Licocene PP MA 7452 GR TP:

PP-g-MA, maleic anhydride-grafted metallocene polypropylene wax (Clariant)

Hostaform C9021 Natural:

POM, MFI 8 g/10 min, flexural modulus 2800 MPa (Ticona)

Celanex 2002-2 Natural:

PBT, MFI 20, flexural modulus 2500 MPa (Ticona)

### Example 1

The film is produced on a single-screw extrusion unit with a flat die having a flexible die lip in one layer, with a downstream chill roll station and a single-stage short-gap drawing unit.

Dow 7C06, Celanex 2002-2 natural, and Licocene PP MA 7452 GR TP are mixed in a ratio of 15:4:1 and the mixture is extruded. The die temperature is 230° C. Chill roll temperatures and drawing roll temperatures are set such that the crystallinity of the film before and after the drawing operation is as high as possible. The draw ratio is 1:5.

Film Properties:

| | |
|---|---|
| Carrier thickness after drawing/μm | 80 |
| Stress at 1% elongation/MPa | 23.6 |
| Stress at 10% elongation/MPa | 154 |
| Tensile strength/MPa | 220 |
| Elongation at break/% | 26 |
| Tear propagation resistance/N/mm | 1220 |
| Tensile impact toughness, transverse/mJ/mm² | 63 |

The film is corona-pretreated on both sides, and on the top face is coated with a 0.5% strength solution of PVSC in toluene, as a release, and is dried. The adhesive is mixed in the melt from 42% by weight of SIS elastomer, 20% by weight of pentaerythritol ester of hydrogenated rosin, 37% by weight of a C₅ hydrocarbon resin having an R&B value of 85° C., and 1% by weight of Irganox® 1010 antioxidant, and is applied to the bottom face of the film at 150° C. using a die. The adhesive tape is then wound to form a stock roll, and for further testing is slit to a width of 15 mm.

Technical Adhesive Data:
Bond strength to steel 2.4 N/cm
Unwind force at 0.3 m/min 1.0 N/cm
Coat weight 24 g/m².

### Example 2

The film is produced on a coextrusion unit with a flat die having a flexible die lip in three layers in ABA construction, with a downstream chill roll station and a single-stage short-gap drawing unit. Both outer layers are composed of Bormod HD 905 CF. The middle layer is composed of Bormod HD 905 CF, Hostaform C9021 natural, and EVAL G156B, mixed in a ratio of 44:5:1. The die temperature is 230° C. Chill roll temperatures and drawing roll temperatures are set such that the crystallinity of the film before and after the drawing operation is as high as possible. The draw ratio is 1:8.

| Film properties: | |
|---|---|
| Carrier thickness after drawing/μm | 60 |
| Stress at 10% elongation/MPa | 264 |
| Tensile strength/MPa | 297 |
| Tear propagation resistance/N/mm | 1600 |
| Elongation at break/% | 12.7 |
| Tensile impact toughness, transverse/mJ/mm² | 150 |

The film is corona-pretreated on both sides and is coated on the top face with a solvent-free silicone which is subsequently crosslinked by UV radiation. The bottom face is provided with a primer composed of natural rubber, cyclo rubber, and 4,4′-diiso-cyanatodiphenylmethane. The adhesive is dissolved in hexane in a kneading apparatus, from 40% by weight of natural rubber SMRL (Mooney 70), 10% by weight of titanium dioxide, 37% by weight of a C₅ hydrocarbon resin having an R&B value of 95° C., and 1% by weight of Vulkanox® BKF antioxidant. The 20% by weight adhesive is applied using a coating bar to the primed bottom face of the film, and is dried at 115° C. The adhesive tape is then wound to form a stock roll, and for further testing is slit to a width of 15 mm.

Technical Adhesive Data:
Bond strength to steel 1.8 N/cm
Unwind force at 0.3 m/min 0.3 N/cm
Coat weight 23 g/m².

### Comparative Example 1

A film and an adhesive tape are produced in the same way as in example 1 from Dow 7C06, with a draw ratio of 1:6.1.

| Film properties: | |
|---|---|
| Carrier thickness after drawing/μm | 80 |
| Stress at 1% elongation/MPa | 16 |
| Stress at 10% elongation/MPa | 142 |
| Tensile strength/MPa | 247 |
| Elongation at break/% | 32 |
| Tear propagation resistance/N/mm | 240 |
| Tensile impact toughness, transverse/mJ/mm² | 258 |

### Comparative Example 2

Dow 7C06 and Styron 457 are mixed in a ratio of 4:1 and from this mixture a film and an adhesive tape are produced in the same way as in example 1, with a draw ratio of 1:8.

| Film properties: | |
|---|---|
| Carrier thickness after drawing/μm | 70 |
| Stress at 1% elongation/MPa | 12 |
| Stress at 10% elongation/MPa | 222 |
| Tensile strength/MPa | 260 |
| Elongation at break/% | 39 |
| Tear propagation resistance/N/mm | 217 |
| Tensile impact toughness, transverse/mJ/mm² | 312 |

### Comparative Example 3

Dow 7C06 and Dowlex 2032 are mixed in a ratio of 41:9 and from this mixture a film and an adhesive tape are produced in the same way as in example 1, with a draw ratio of 1:6.4.

| Film properties: | |
|---|---|
| Carrier thickness after drawing/μm | 120 |
| Stress at 1% elongation/MPa | 30.3 |
| Stress at 10% elongation/MPa | 174 |
| Tensile strength/ MPa | 335 |
| Elongation at break/% | 33.4 |
| Tear propagation resistance/N/mm | 284 |
| Tensile impact toughness, transverse/mJ/mm² | 240 |

1. A polyolefin film for an adhesive tape, which is oriented monoaxially in longitudinal direction, wherein the film comprises a mixture of an olefinic polymer and a polar nonolefinic polymer.

2. The polyolefin film according to claim 1, wherein the fraction of polar nonolefinic polymer in the mixture is in the range from 5% to 30% by weight.

3. The polyolefin film according to claim 1, wherein the nonolefinic polymer is a homopolymer or copolymer of propylene.

4. The polyolefin film according to claim 1, wherein the film is composed of a matrix of olefinic polymer, in which fibers of the polar nonolefinic polymer are embedded, and wherein the fibers have a diameter of 0.01 to 50 μm.

5. The polyolefin film according to claim 1, wherein the film has
a draw ratio in longitudinal direction of at least 1:4.5,
a tensile strength in longitudinal direction of at least 200 N/mm²,
a stress at 10% elongation in longitudinal direction of at least 150 N/mm², and
a tear propagation resistance in transverse direction of at least 400 N/mm.

6. The polyolefin film according to claim 1, wherein the film has a thickness of 15 to 200 μm.

7. The polyolefin film according to claim 3, wherein the olefinic polymer comprises at least 50% by weight propylene, and is a propylene homopolymer.

8. The polyolefin film according to claim 1, wherein the polar nonolefinic polymer is selected from the group consisting of polyesters, polyamides, polyoxymethylene, polyarylene sulfides, polyarylene oxides, polyurethanes, and polybutylene terephthalate.

9. The polyolefin film as claimed in claim 1, wherein the mixture comprises as a third component a polar-modified polyolefin preferably from the group of the copolymers of olefins with vinyl esters, methacrylic acid and acrylic acid, more preferably ethylene-vinyl acetate copolymers and ethylene-(meth)acrylate copolymers, and esters thereof, or from the group of graft polymers with an unsaturated organic acid, more preferably a maleic anhydride-, methacrylic acid- or acrylic acid-grafted polyolefin, and the fraction of polar-modified polyolefin in this mixture is preferably in the range from 0.2% to 10% by weight.

10. The polyolefin film according to claim 1, wherein the film has a coextrusion layer on at least one outer face, wherein the coextrusion layer comprises polyolefinic polymer.

11. (canceled)

12. The polyolefin film according to claim 1, wherein the film comprises an an adhesive applied to at least one side of the film.

13. (canceled)

14. The polyolefin film according to claim 1 wherein the polar nonolefinic polymer is partially crystalline.
